(19) United States
(12) Patent Application Publication
(10) Pub. No.: US 2017/0058187 A1
(43) Pub. Date: Mar. 2, 2017

(54) ENHANCED OIL RECOVERY METHOD FOR PRODUCING LIGHT CRUDE OIL FROM HEAVY OIL FIELDS

(71) Applicant: Awad Rasheed Suleiman Mansour, Chicago Ridge, IL (US)

(72) Inventor: Awad Rasheed Suleiman Mansour, Chicago Ridge, IL (US)

(21) Appl. No.: 14/839,077

(22) Filed: Aug. 28, 2015

(51) Int. Cl. C09K 8/584; E21B 43/16

(52) U.S. Cl. CPC C09K 8/584; E21B 43/16; C09K 2208/10

(57) ABSTRACT

The present invention relates to a nano-fluid composition for use in a method for enhanced oil recovery comprising a sultaine compound, a solvent or mixture of solvents comprising hydrocarbons having 5 to 12 carbons, and nanoparticles selected from Magnesia, Alumina and Zinc Oxide. The present invention provides also a novel method for enhanced oil recovery involving injection of the said nano-fluid composition into a subterranean formation and obtaining material comprising petroleum from a subterranean formation downhole.

### FIELD OF THE INVENTION

The present invention relates to an in situ process for stimulated and enhanced oil recovery, and more particularly, the invention pertains to production of light crude oil from heavy oil reservoirs by using enhanced oil recovery techniques.

### BACKGROUND OF THE INVENTION

Enhanced oil recovery (EOR) is used to increase oil recovery from crude oil-bearing rocks. There are basically three main types of EOR processes; thermal, chemical/polymer, and gas injection, each of which may be used worldwide to increase oil recovery from a reservoir beyond what would otherwise be possible with conventional crude oil recovery means. These methods may also extend the life of the reservoir or otherwise boost its overall oil recovery factor.

Oil production is separated into three phases: primary, secondary and tertiary, which is also known as Enhanced Oil Recovery (EOR). Primary oil recovery is limited to hydrocarbons that naturally rise to the surface, or those that use artificial lift devices, such as pump jacks. Secondary recovery employs water and gas injection, displacing the oil and driving it to the surface. According to the US Department of Energy, utilizing these two methods of production can leave up to 75% of the oil in the well.

The way to further increase oil production is through the tertiary recovery method or EOR. Although more expensive to employ on a field, EOR can increase production from a well to up to 75% recovery. Used in fields that exhibit heavy oil, poor permeability and irregular faultlines, EOR entails changing the actual properties of the hydrocarbons, which further distinguishes this phase of recovery from the secondary recovery method. While water flooding and gas injection during the secondary recovery method are used to push the oil through the well, EOR applies steam or gas to change the makeup of the reservoir.

Whether it is used after both primary and secondary recovery have been exhausted, or at the initial stage of production, EOR restores formation pressure and enhances oil displacement in the reservoir.

There are three main types of EOR, including chemical flooding, gas injection and thermal recovery. Increasing the cost of development alongside the hydrocarbons brought to the surface, producers do not use EOR on all wells and reservoirs. The economics of the development equation must make sense. Therefore, each field must be heavily evaluated to determine which type of EOR will work best on the reservoir. This is done through reservoir characterization, screening, scoping, and reservoir modeling and simulation.

Thermal recovery introduces heat to the reservoir to reduce the viscosity of the oil. Many times, steam is applied to the reservoir, thinning the oil and enhancing its ability to flow. First applied in Venezuela in the 1960s, thermal recovery now accounts for more than 50% of applied EOR in the US.

Chemical injection EOR helps to free trapped oil within the reservoir. This method introduces long-chained molecules called polymers or surfactants or both into the reservoir to increase the efficiency of water flooding or to boost the effectiveness of surfactants, which are cleansers that help lower surface tension and inhibits the flow of oil through the reservoir. U.S. Pat. No. 5,363,915 for instance discloses a method of enhancing recovery of petroleum from an oil bearing formation whereby non-ionic surfactants such as ethoxylated alkyl phenols; ethoxylated linear secondary alcohols; propoxylated and ethoxylated primary alcohols are used in combination with a gas phase. Less than 1% of all EOR methods presently utilized in the US consist of chemical injections.

Gas injection used as a tertiary method of recovery involves injecting of natural gas, nitrogen or carbon dioxide into the reservoir. The gases can either expand and push gases through the reservoir, or mix with or dissolve within the oil, decreasing viscosity and increasing flow. U.S. Pat. No. 4,418,753 discloses such a method involving injection of a nitrogen containing gas after an initial injection of light hydrocarbon slug to the reservoir.

CO₂-EOR is the method that is gaining the most popularity. While initial CO₂-EOR developments used naturally occurring carbon dioxide deposits, technologies have been developed to inject CO2 created as byproducts from industrial purposes. US-A-2013/0025866, for instance, discloses an integrated EOR process whereby a CO₂ stream is generated by burning fuel, which is injected later on into an oil production reservoir. First employed in the US in the early 1970s in Texas, CO₂-EOR is successfully used in Texas and New Mexico and is expected to become more widely spread in the future. Nearly half of the EOR employed in the US is a form of gas injection.

Other EOR applications gaining acceptance are low-salinity water flooding, which is expected to increase production by nearly 20%, and well stimulation, which is a relatively low-cost solution because it can be employed to single wells (rather than the whole reservoir). There are other new technologies using ionic liquids or nanotechnology but they are still in R&D stages and lab scale.

In the area of the 6 Gulf States oil experts estimated oil reserves that do need efficient EOR technologies for more than 475 billion bbl of oil. The global market for EOR technologies was $4.7 billion in 2009 and is expected to grow rapidly in the upcoming years. Therefore, there is a continuing need for enhanced oil recovery methods especially in subterranean formations containing heavy petroleum with high viscosity.

### BRIEF DESCRIPTION OF THE DRAWINGS

FIG. 1 shows a simulated distillation analysis of an oil sample treated with nano-fluid according to the present invention.

FIG. 2 is a diagram showing crude oil recovery with a method involving slug solvent flooding.

FIG. 3 is a diagram showing crude oil recovery in an other scenario where the oil is pretreated with the nano-fluid according to the present invention.

### DETAILED DESCRIPTION OF PREFERRED EMBODIMENTS

The present disclosure provides an enhanced oil recovery process for producing light crude oil from heavy crude oil reservoirs. A key advantage in the technology disclosed herein is that as the nano-fluid according to this invention is injected into the formation and mixed with heavy oil, it produces a much lighter oil with low viscosity which is similar to viscosity of water. The nano-fluid is believed to solubilize the oil to create a new light crude oil that exhibits a lower viscosity than the non-solubilized oil. The mixture is then efficiently mobilized and recovered with standard methods.

In one aspect, the present invention is directed to a method for producing light crude oil, comprising, placing a nano-fluid into a formation comprising heavy crude oil. Preferably, the oil treated according to the instant invention has a viscosity of at least 40,000 cP, and more preferably 40,000 cP to 57,000 cP at 30° C.

In another aspect, the present invention is directed to a process for producing light crude oil from a formation containing heavy crude oil whereby the oil recovered has a lower density and lower boiling point such that it is easy to recover it from the well with high efficiency, and easy to distillate and separate its components.

The nano-fluid according to the present invention comprises basically a solvent mix and nano-particles as disclosed herein.

The solvent mix according to the present invention comprises sultaines as a wetting agent and interfacial tension (IFT) reducer, and further comprises a hydrocarbon solvent having 5 to 12 carbons.

In the context of the present invention, sultaines are represented by Formula I, or isomers and metal salts thereof:

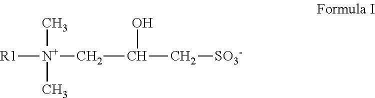

wherein;
R1 is either an alkyl or an alkyl amidoalkyl group, and said alkyl group in either case can be a branched or a straight chain alkyl group having 6-18 carbon atoms, and most preferably 10-14 carbon atoms. Commercially available sultaines include: lauryl hydroxy sultaine, tallowamidopropyl hydroxy sultaine, erucamidopropyl hydroxy sultaine, and alkylether hydroxypropyl sultaine. The inventor has obtained best results with alkyl ether hydroxypropyl sultaine.

The hydrocarbon solvent having 5 to 12 carbon atoms, as referred to in the context of the present invention can, for instance be alkanes including pentane and hexane, heptane and octane or isomers thereof, and various condensates or distillates of crude oil, such as naphtha having 5-6 carbon atoms (light naphtha) or 6-12 carbon atoms (heavy naphtha). The inventor has obtained best results with a mixture of solvents comprising light naphtha, n-pentane and n-heptane.

A further component of the nano-fluid used in an EOR method according to the present invention is the nanoparticles which are functioning for breaking of heavy oil molecules into light ones. Therefore, these nanoparticles behave as a kind of a room temperature catalyst in the presence of a solvent mix as mentioned above. The said nanoparticles according to the present invention are selected from the group consisting of Magnesia (Magnesium Oxide), Alumina (Aluminuim Oxide) and Zinc Oxide or hydrated forms thereof, nanoparticles and combinations thereof. In preferred embodiments, the nano-fluid comprises at least two, more preferably three, and most preferably all of the mentioned nanoparticles.

Therefore, in an aspect of the present invention, there is provided a nano-fluid composition for use in enhanced oil recovery from a subterranean formation comprising;
a sultaine compound of formula I as defined above, or an isomer or metal salt thereof,
a solvent or mixture of solvents comprising hydrocarbons having 5 to 12 carbons, and
nanoparticles selected from Magnesia (Magnesium Oxide), Alumina (Aluminuim Oxide) and Zinc Oxide.

In a more particular embodiment of the present invention, said nano-fluid composition comprises the following components;
alkyl ether hydroxypropyl sultaine,
a hydrocarbon solvent mixture comprising light naphtha, n-pentane and n-heptane, and
nanoparticles comprising Magnesia (Magnesium Oxide), Alumina (Aluminuim Oxide) and Zinc Oxide.

In another aspect of the present invention, a method for producing the aforesaid composition is provided, and this method comprises the steps of;
dissolving the sultaine compound as defined above in solvent(s) comprising hydrocarbons having 5 to 12 carbons,
adding nanoparticles mentioned above into the solution, and
obtaining a nano-fluid composition.

In a further aspect of the present invention, there is provided a method of enhanced oil recovery, comprising the steps of:

providing a nano-fluid composition comprising:
a sultaine compound of formula I as defined above, or an isomer or metal salt thereof,
a solvent or mixture of solvents comprising hydrocarbons having 5 to 12 carbons, and
nanoparticles selected from Magnesia (Magnesium Oxide), Alumina (Aluminuim Oxide) and Zinc Oxide,
   injecting the nano-fluid composition into a subterranean formation, and
   obtaining material comprising petroleum from a subterranean formation downhole.

The method provided herein is noted to be quite cost effective and fast as compared to other technologies. It is also environmentally safe and has no side effects on ground water, rock permeability or composition of crude oil. Surprisingly, the inventor has also noted that high percentage of the produced oil can be refined (distilled) and an increase in the produced volume of crude oil as demonstrated in the examples. Therefore, the invention and its particular effects shall be demonstrated with the exemplary explanations with reference to site studies and experimental assays, which however are in no way limiting the scope of protection conferred by the claims appended hereto.

### EXAMPLES

### Nano-Fluid Composition

A solvent mix was prepared by a homogenous mixture of naphtha, n-pentane and n-heptane. Alkyl ether hydroxypropyl sultaine was dissolved in this mixture and the resulting solution was added with nanoparticles of Magnesia (Magnesium Oxide), Alumina (Aluminuim Oxide) and Zinc Oxide under continuous stirring to obtain the final composition. Hereinafter, the method involving use of this composition shall be called MOVIS.

### EOR Techniques Currently in Use in Oman Petroleum Sites

Polymer injection: When reservoirs contain heavier grades of crude, the viscosity of the oil restricts its flow to the well. With such a heavy grade of crude, water injection might not prove effective, as the disparity in viscosity causes the water to pass the oil instead of pushing it to the well. At Oman's Marmul project, with its heavy oil, injecting polymer fluid is more effective than other EOR techniques such as steam injection. In 2012, Marmul produced approximately 75,000 bbl/d.

Miscible gas injection: Miscible gas injection involves pumping gas, often toxic, that dissolves in the oil, facilitating higher flow rates. Operators at Oman's Harweel oil field cluster use this technique in their operations. As a result, Harweel produced an additional 23,000 bbl/d in 2012, and production could continue to increase by another 30,000 bbl/d in the near term.

Steam injection: Thermal EOR entails the injection of steam in various ways and durations to facilitate the flow of heavier oil to the well. In Oman, operators use thermal EOR methods at Mukhaizna, Marmul, Amal-East, Amal-West, and Qarn Alam fields, among others. Thermal EOR could increase production at both Amal-East and Amal-West to 23,000 bbl/d by 2018. Furthermore, the steam injection at Qarn Alam should increase production by 40,000 bbl/d by 2015 through a novel process in which the steam drains oil to lower producer wells.

To facilitate a better understanding of this technology for EOR, the following examples are given from Oman.

### Tests Involving Nano-Fluid Composition of the Invention

Encouraged by the results obtained in the improvements of quality, reduction of the viscosity and increase in API gravity of crude oil by EOR technology, it was suggested to conduct further tests at the test facilities using out crude oil samples from the sites below:
Amal East
Amal West
Mukhaizna
Refinery Long Residue
Zahir
Nimer

The inventor, Prof. Awad Mansour, processed the crude oil samples with MOVIS technology of the present invention for about 5 minutes. The Processed samples were then analyzed to determine the upgrading of crude oil, reduction of viscosity and increase of API gravity. The following analysis was conducted:
Viscosity measurements. These were then used to calculate the theoretical reduction in pipeline pressure drop.
Density measurements at 15° C. These were then used to determine quality improvement of the crude oil by calculating their new API gravities.

Comparisons were then made for all the six samples, before processing and after processing with the present technology.

### Results—Part 1: Oil Sample Density

Density Measurements:

TABLE 1
Density measurements @15° C.

| | Density, | |
|---|---|---|
| | kg/m3 | API |
| Fresh crude oil before treatment | 936.2 | 19.6 |
| Oil after treatment (5 min) | 915.3 | 23.1 |

### Results—Part 2: Simulated Distillation

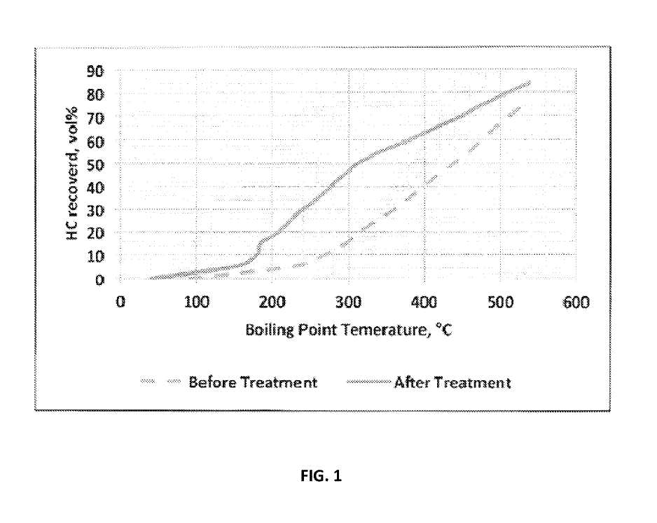

FIG. 1 shows the accumulative recovery of hydrocarbons as a function of their boiling temperature. It is clear from the figure that MOVIS technology dramatically enhanced the properties of the crude oil.
The initial boiling point decreased from 91.6° C. to 40.2° C.
The cumulative recovered HC at 300° C. was only 16 vol % for the original crude oil compared to 47 vol % after processing (treatment) with the novel technology.
The heavy residue (boiling point temperature>540° C.) decreased from 26 vol % for original crude oil to just 16 vol % after processing (treatment) with the novel technology.
   Results—Part 3. Oil Sample Densities from Six Known Oil Samples

Comparison of Density Measurements:

TABLE 2
Density measurements @15° C.

| | Treatment | Before treatment | | After treatment | | Oil Quality, API |
|---|---|---|---|---|---|---|
| Oil Source | time, min | Density kg/m³ | API | Density kg/m³ | API | Improvement. % |
| Amal E | 6 | 968.1 | 14.7 | 946.9 | 17.9 | 22.3 |
| Amal W | 5 | 949.2 | 17.6 | 919.8 | 22.3 | 27.1 |
| Mukhaizna | 10 | 983.1 | 12.4 | 964.5 | 15.2 | 22.3 |
| LR^{a} | 10 | 951.9 | 17.2 | 929.9 | 20.7 | 20.5 |
| Zahir | 8 | 957.2 | 16.3 | 945.3 | 18.2 | 11.4 |
| Nimer | 6 | 934.3 | 20.0 | 923.3 | 21.8 | 9.0 |

^{a}LR = Long Residue of Muscat Refinery (MAF)

### Comparison of Viscosity Measurements & Pressure Drop Calculations

Table 3 summarizes the obtained results. For the pressure drop calculations, the properties of a 24″ schedule 40 commercial steel pipe were used and a crude velocity of 1 m/s was assumed.

TABLE 3
Viscosity measurements and pressure drop calculation before and after treatments

| | | Viscosity | | | Pressure drop | | |
|---|---|---|---|---|---|---|---|
| | Treatment | Measurement cP A 30° C. | | | calculation, Pa/m | | |
| Oil Source | time, min | Before | After | Reduction % | Before | After | Reduction % |
| Amal E | 6 | 40000 | 3140 | 92 | 3444 | 270 | 92 |
| Amal W | 5 | 3642 | 372 | 90 | 314 | 32 | 90 |
| Mukhaizna | 10 | 56600 | 4470 | 92 | 4874 | 385 | 92 |
| LR^{a} | 10 | 5830 | 1720 | 70 | 502 | 148 | 70 |
| Zahir | 8 | 4525 | 1192 | 74 | 390 | 103 | 74 |
| Nimer | 6 | 2770 | 555 | 80 | 239 | 48 | 80 |

^{a}LR = Long Residue of Muscat Refinery (MAF)

It is clear from the tables above that the novel technology is real and effective in terms of crude oil quality improvement. The viscosity reduction and hence pressure drop reduction ranged from 70% to more than 90%.

The obtained results clearly show high efficiency and effectiveness of the novel composition of the invention to improve the oil quality by increasing the API gravity and decrease the oil viscosity. Moreover, the simulated distillation of crude oil shows the dramatic improvement in percentage of hydrocarbon recovery at any given temperature, and overall recovery at highest temperature 540° C. The reduction in viscosity can be explained due to the oil API improvement as well as the suspension of the asphalt, paraffin and sulfur particles due to the effect of the novel composition. The nano particles as well as the nature of solvent mix transform heavy crude oil, into light oil and therefore various improvements in physicochemical properties of the oil are observed. It is believed that the composition of the present invention breaks down long chain of hydrocarbon to shorter ones.

### Core Flooding Tests

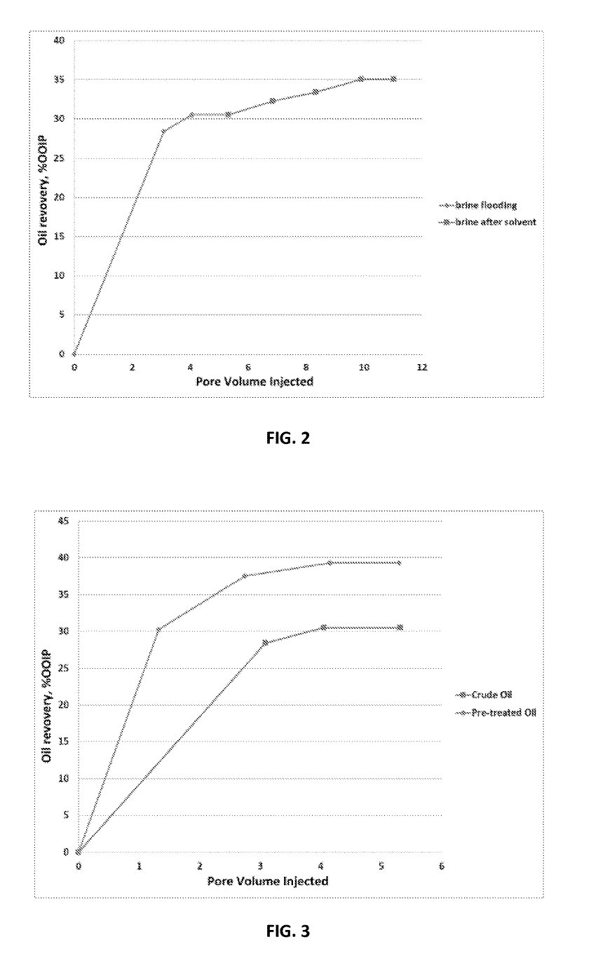

Core-flood tests were conducted to investigate the potential of the MOVIS technology in enhancing the recovery of Mukhaizna heavy crude oil at conditions similar to those conditions in the reservoir. The tests were carried out with fresh Berea core samples at 40° C. Two scenarios were considered. The first was to determine the enhancement in oil recovery if the solvent is to be injected into the reservoir as a tertiary slug solvent flooding. The second considered scenario was to pretreat Mukhaizna oil outside the core then determine any in extra recovery factor via water-flooding compared to that for not treated Mukhaizna oil. The experimental conditions, initial conditions, and results of recovery factors are shown in Table 4. FIGS. 2 and 3 show the results of oil recovery factor increments on the basis of original oil in place (OOIP). The MOVIS technology proved to be effective in enhancing the recovery of Mukhaizna heavy oil, as 5% and 10% of OOIP extra recovery were achieved via scenario 1 and 2 respectively.

TABLE 4
Experimental conditions and summary of the core-flood results

| | Scenario 1: | Scenario 2: |
|---|---|---|
| | Tertiary | Pre-treated |
| | Slug Solvent | oil recovery |
| | Flooding | by brine flooding |
| Condition | 40° C., 1200 psi | 40° C., 1200 psi |
| Core length, cm | 15.1 | 14.8 |
| Core diameter, cm | 3.8 | 3.8 |
| Brine permeability, mD | 97 | 87 |
| Porosity, % | 20.3 | 20.2 |
| Pore volume, cc | 35.5 | 34 |
| Initial oil in place, cc | 28.5 | 27.5 |
| Initial oil saturation, Soi | 80.2% | 80.8% |
| Connate water saturation, | 19.8% | 19.1% |
| Scw | | |
| Oil recovery by brine | 30.52% by 5.6 PV | 39.4% by 5.3 PV |
| flooding, | of injection | of injection |
| Oil recovery by brine | 4.5% | |
| flooding after 1.5 cc | | |
| solvent injection | | |

### Formation Damage

The result of the formation-damage study is presented in Table 5. The differential pressure drop measurements before and after the injection of the MOVIS solvent showed no damage to the cores at 40° C. In fact, there was a small reduction in the differential pressure drop that might be interpreted as the opposite of formation damage. Having said that, the conducted formation damage test was of the most elementary type. Considering the short period of aging, small amount of injected solvent, the results can not be conclusive. A more comprehensive study might be recommended if such technology is to be used for EOR.

TABLE 5
Results for the formation damage study

| | | |
|---|---|---|
| Experimental | Temperature, ° C. | 40 |
| conditions | Pressure, psi | 1200 |
| Core properties | Length, cm | 15.1 |
| | Diameter, cm | 3.8 |
| | Porosity, % | 20.3 |
| | Pore volume, cc | 35.5 |
| Pressure drop, psi | Before solvent injection | 550 |
| | After solvent injection | 528 |

### Additional Tests

The purpose of this test is to investigate the effectiveness of the proposed technology to upgrade the heavy oil using lower solvent to oil ration. The test conditions as pre-specified by the inventor were as follow:
MOVIS solvent: 2 cc of MOVIS solvent for each 100 cc of heavy oil
MOVIS nano particles: 0.1 ppm in oil
Treatment time: 20 minutes
Source of heavy oil: Mukhaizna oil
   The results were as follows:

TABLE 6
Results of additional tests

| | Before | After | |
|---|---|---|---|
| | treatment | treatment | % Change |
| Viscosity at 30° C., cP | 10,345 | 1,567 | 85 |
| Density at 15° C., kg/m³ | 963.1 | 946.0 | 1.8 |
| API | 15.28 | 17.93 | 17.3 |
| Sulfur content, wt % | 2.538 | 2.150 | 15.3 |
| Oil volume, cc | 300 | 350 | 16.6 |

From Table 6 it can be easily noticed that nano particles as well as the nature of the nano solvent mix transform heavy crude oil, into light oil and therefore various improvements in physicochemical properties of viscosity, API, light fractions percentage and sulfur content of the crude oil are observed. It is believed that the composition of the present invention breaks down long chain of hydrocarbon to shorter ones. Moreover it can be noticed from Table 6 there is an increase in crude oil volume which means MOVIS TECHNOLGY introduced an added value to the treated crude oil by at least 17%.

1. A nano-fluid composition comprising:
a sultaine compound of the formula: 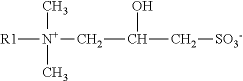
or isomers, and metal salts thereof,
wherein; R1 is either an alkyl or an alkyl amidoalkyl group, having branched or a straight chain, and having 6-18 carbon atoms,
a solvent or mixture of solvents comprising hydrocarbons having 5 to 12 carbons, and
nanoparticles selected from Magnesia, Alumina and Zinc Oxide.

2. A composition according to claim 1 wherein R1 has 10 to 14 carbon atoms.

3. A composition according to claim 1 wherein said sultaine compound is selected from the group consisting of lauryl hydroxy sultaine, tallowamidopropyl hydroxy sultaine, erucamidopropyl hydroxy sultaine, and alkyl ether hydroxypropyl sultaine.

4. A composition according to claim 1 wherein said sultaine compound is alkyl ether hydroxypropyl sultaine.

5. A composition according to claim 1 wherein the solvent of 5 to 12 carbon atoms is selected from alkane(s) and condensates or distillates of crude oil.

6. A composition according to claim 5 wherein the solvent is selected from the group consisting of light naphtha, n-pentane and n-heptane.

7. A composition according to claim 1 comprising:
alkyl ether hydroxypropyl sultaine,
a hydrocarbon solvent mixture comprising light naphtha, n-pentane and n-heptane, and
nanoparticles comprising Magnesia, Alumina and Zinc Oxide.

8. A method for the preparation of a nano-fluid composition as defined in claim 1, comprising the steps of:
a. dissolving the sultaine compound as defined in claim 1 in solvent(s) comprising hydrocarbons having 5 to 12 carbons,
b. adding nanoparticles selected from Magnesia, Alumina and Zinc Oxide into the solution, and
c. obtaining the final nano-fluid composition.

9. A method of enhanced oil recovery, comprising the steps of:
providing a nano-fluid composition comprising:
a sultaine compound of formula I as defined in claim 1, or an isomer or metal salt thereof,
a solvent or mixture of solvents comprising hydrocarbons having 5 to 12 carbons, and nanoparticles selected from Magnesia, Alumina and Zinc Oxide,
injecting the nano-fluid composition into a subterranean formation, and
obtaining material comprising petroleum from a subterranean formation downhole.

10. A method according to claim 9 wherein the sultaine compound is selected from the group consisting of lauryl hydroxy sultaine, tallowamidopropyl hydroxy sultaine, erucamidopropyl hydroxy sultaine, and alkyl ether hydroxypropyl sultaine.

11. A method according to claim 10 said sultaine compound is alkyl ether hydroxypropyl sultaine.

12. A method according to claim 9 wherein the solvent of 5 to 12 carbon atoms is selected from alkane(s) and condensates or distillates of crude oil.

13. A method according to claim 12 wherein the solvent is selected from the group consisting of naphtha, n-pentane and n-heptane.

14. A method according to claim 9 wherein the nano-fluid composition comprises:
alkyl ether hydroxypropyl sultaine,
a hydrocarbon solvent mixture comprising light naphtha, n-pentane and n-heptane, and nanoparticles comprising Magnesia, Alumina and Zinc Oxide.

15. A method according to claim 9 wherein the petroleum that is to be treated with nano-fluid composition has a viscosity of at least 40,000 centipoise at 30° C.
